(19) United States
(12) Patent Application Publication
(10) Pub. No.: US 2026/0125937 A1
(43) Pub. Date: May 7, 2026

(54) HANDLE DEVICE AND DOOR DEVICE

(71) Applicant: ALPHA CORPORATION, Kanagawa (JP)

(72) Inventors: Takashi ONO, Kanagawa (JP); Yutaka SAITO, Kanagawa (JP); Noriaki ITO, Kanagawa (JP); Masaya WAKAMATSU, Kanagawa (JP)

(73) Assignee: ALPHA CORPORATION, Kanagawa (JP)

(21) Appl. No.: 19/434,676

(22) Filed: Dec. 29, 2025

Related U.S. Application Data
(63) Continuation of application No. PCT/JP2024/023899, filed on Jul. 2, 2024.

(30) Foreign Application Priority Data
Jul. 5, 2023 (JP) 2023-110880

(51) Int. Cl. E05B 85/16; E05B 79/20

(52) U.S. Cl. CPC E05B 85/16; E05B 79/20

(57) ABSTRACT

A handle device includes a base, a lever, a first biasing portion, an indoor handle, a second biasing portion, a latch-side routing member, and a cylinder-side routing member. The lever includes, at a connection portion with the cylinder-side routing member, an elongated hole portion having an arc shape around a rotation shaft, and a connection end of the cylinder-side routing member is accommodated and held in the elongated hole portion, and is moved in the elongated hole portion when the lever is locked to the indoor handle and is rotated.

### CROSS-REFERENCE TO RELATED APPLICATIONS

This is a continuation of International Application No. PCT/JP2024/023899 filed on Jul. 2, 2024, and claims priority from Japanese Patent Application No. 2023-110880 filed on Jul. 5, 2023, the entire content of which is incorporated herein by reference.

### TECHNICAL FIELD

The present disclosure relates to a handle device and a door device.

### BACKGROUND ART

JPH04116569U discloses a door lock device that includes a door lock having a latch, the latch is engaged with a striker of a vehicle body to hold a door in a closed state. In this door lock device, an outside handle and an inside handle used for releasing the engagement of the latch with the striker to open the door lock are connected to the door lock.

However, in the door lock device described in JPH04116569U, each of the outside handle and the inside handle is connected to the door lock by a rod. That is, the door lock device has a complicated structure in which the rod connecting the outside handle to the door lock and the rod connecting the inside handle to the door lock are routed in two paths, and is desired to be improved in terms of assembly workability, weight, and cost.

The present disclosure provides a handle device and a door device that can be favorably assembled while reducing cost and weight with a simple structure.

### SUMMARY

According to the present disclosure, a handle device to be provided in a vehicle door and for releasing engagement of a latch provided in a door lock mechanism of the door with a vehicle body, includes: a base to be attached to the door; a lever supported by the base to be rotatable; a first biasing portion configured to bias the lever in a rotation direction serving as one direction; an indoor handle supported by the base to be rotatable about the same rotation shaft as that of the lever, and configured to be rotated in a rotation direction serving as the other direction to lock the lever and rotate the lever in the rotation direction serving as the other direction; a second biasing portion configured to bias the indoor handle in the rotation direction serving as the one direction; a latch-side routing member connected to the lever and extending forward in the rotation direction serving as the one direction to connect the latch; and a cylinder-side routing member connected to the lever and extending forward in the rotation direction serving as the other direction to connect to a cylinder lock. The lever includes, at a connection portion with the cylinder-side routing member, an elongated hole portion having an arc shape around the rotation shaft, and a connection end of the cylinder-side routing member is accommodated and held in the elongated hole portion, and is moved in the elongated hole portion when the lever is locked to the indoor handle and is rotated.

Further, a door device includes the above handle device; a cylinder lock to which the cylinder-side routing member is connected; and a door lock device to which the latch-side routing member is connected.

### Advantageous Effects of Invention

According to the present disclosure, it is possible to provide a handle device and a door device that can be favorably assembled while reducing cost and weight with a simple structure.

### BRIEF DESCRIPTION OF DRAWINGS

FIG. 1 is a schematic configuration diagram of a vehicle door for illustrating a door device provided with a handle device according to an embodiment;

FIG. 2 is a perspective view of the handle device according to the present embodiment;

FIG. 3 is an exploded perspective view of the handle device according to the present embodiment;

FIG. 4 is a front view of the handle device according to the present embodiment;

FIG. 5 is a rear view of the handle device according to the present embodiment;

FIG. 6 is a cross-sectional view taken along VI-VI in FIG. 4;

FIG. 7 is a cross-sectional view taken along VII-VII in FIG. 4;

FIG. 8 is a view corresponding to the cross-sectional view taken along VI-VI in FIG. 4 for illustrating a movement of the handle device; and

FIG. 9 is a view corresponding to the cross-sectional view taken along VI-VI in FIG. 4 for illustrating a movement of the handle device.

### DESCRIPTION OF EMBODIMENTS

A specific embodiment of the present disclosure will be described below with reference to the drawings.

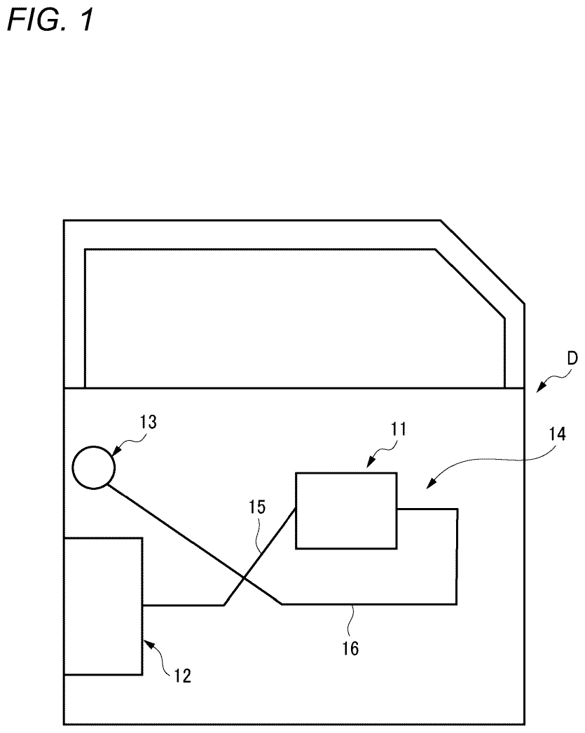

FIG. 1 is a schematic configuration diagram of a vehicle door D for illustrating a door device 14 provided with a handle device 11 according to the present embodiment. In FIG. 1, the right side of the figure is the front side of a vehicle, the left side thereof is the rear side of the vehicle, the upper side thereof is the upper side thereof, and the lower side thereof is the lower side thereof. Further, in the door device 14, the inner side of the vehicle is the front surface side, and the outer side of the vehicle is the rear surface side.

As illustrated in FIG. 1, the handle device 11 according to the present embodiment is provided in the vehicle door D. The door D is provided with a door lock device 12 and a cylinder lock 13. The handle device 11 constitutes the door device 14 together with the door lock device 12 and the cylinder lock 13. For example, the handle device 11 is provided in an inner panel of the door D, and is provided in the vicinity of the vehicle rear side with respect to the vicinity of the center of the door D so as to be easily operated by a passenger sitting on a seat. The cylinder lock 13 is provided in an outer panel of the door D, and is provided on a rotation distal end side of the door D so as to be easily operated by the passenger from the outside of the vehicle. The door lock device 12 is provided between the inner panel and the outer panel of the door D, and is provided on the rotation distal end side of the door D to engage with a striker provided in a vehicle body described later.

The door lock device 12 includes a lock mechanism and a latch (both are not illustrated), and has a double-action structure in which unlocking of the lock mechanism and release of the latch can be performed by two operations of the handle device 11. The door Dis maintained in a closed state and is locked by the lock mechanism in this state by engaging the latch of the door lock device 12 with the striker (not illustrated) provided in the vehicle body.

The handle device 11 is connected to the door lock device 12 by a latch-side cable 15. Further, the handle device 11 is connected to the cylinder lock 13 by a cylinder-side cable 16. As a result, the cylinder lock 13 is connected to the door lock device 12 by the cylinder-side cable 16 and the latch-side cable 15 connected in one path via the handle device 11.

In the door device 14, when the handle device 11 is subjected to an opening operation, an operation force thereof is transmitted as a pulling force to the door lock device 12 via the latch-side cable 15. The lock mechanism is unlocked by a first opening operation of the handle device 11, and the engagement of the striker with the latch is released and the door D is opened by a second opening operation thereof. Further, in the door device 14, when the cylinder lock 13 is subjected to an opening operation, an operation force thereof is transmitted as a pulling force to the latch of the door lock device 12 via the cylinder-side cable 16 and the latch-side cable 15. As a result, the engagement of the striker with the latch is released, and the door D is opened. In this way, in the door device 14, the closed state of the door D achieved by the door lock device 12 can be released by performing the opening operation of the handle device 11 or the cylinder lock 13.

Next, a structure of the handle device 11 will be described.

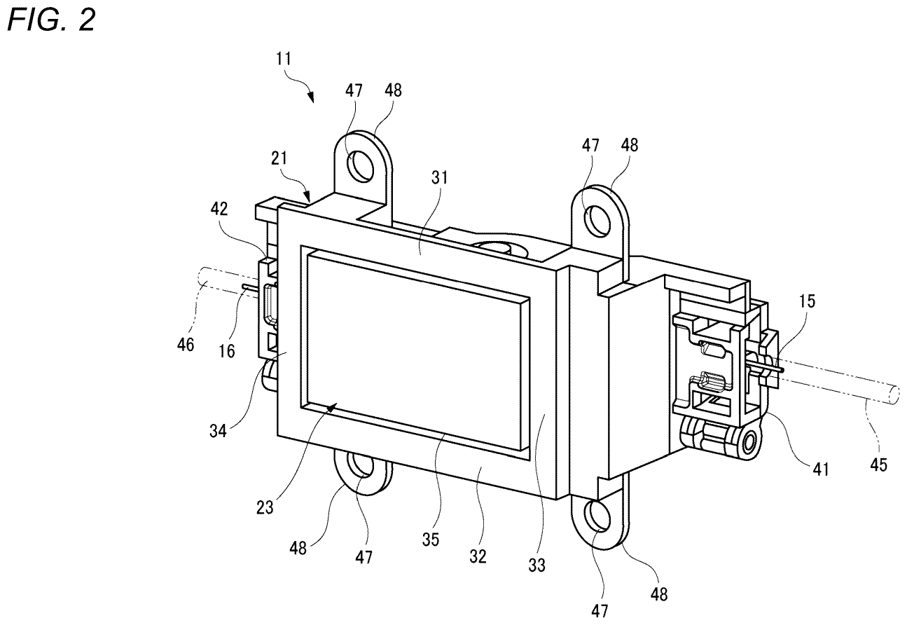

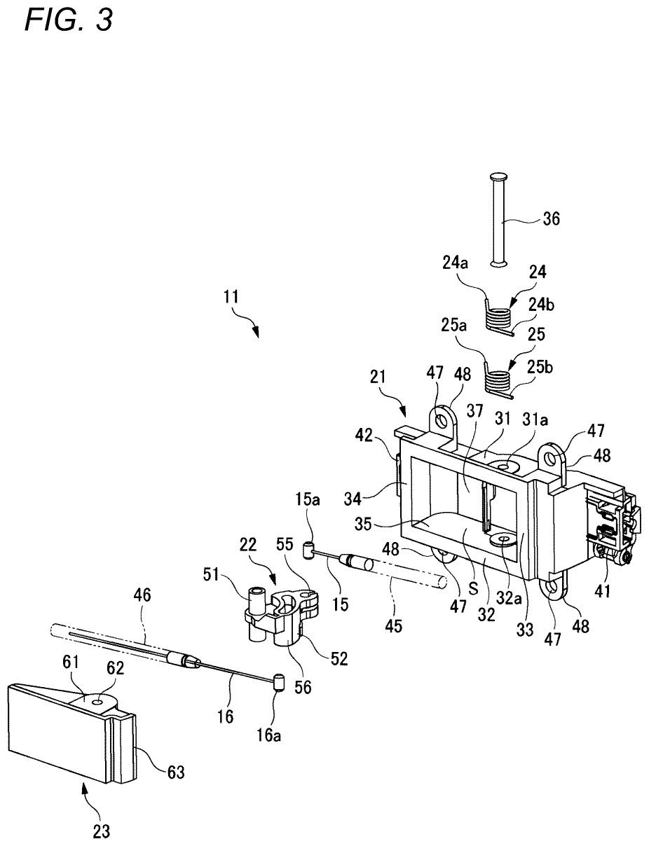

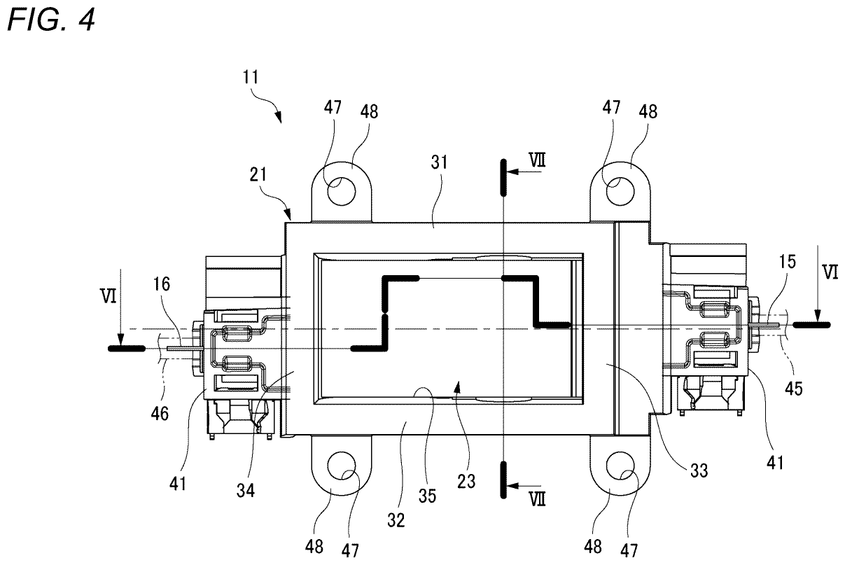

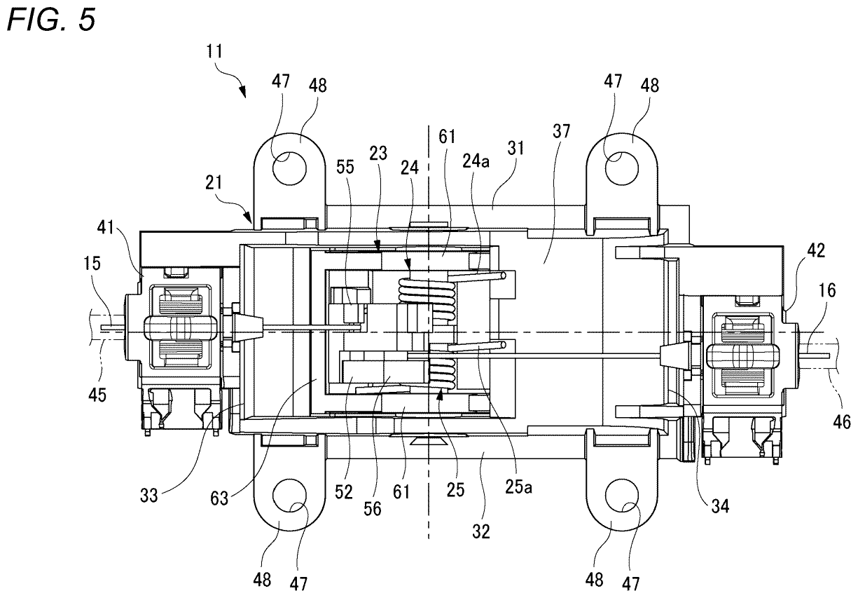

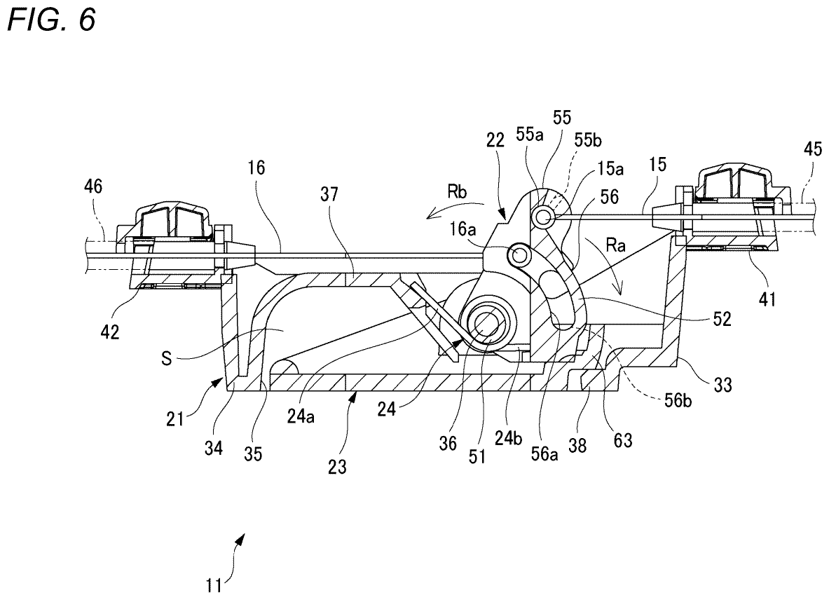

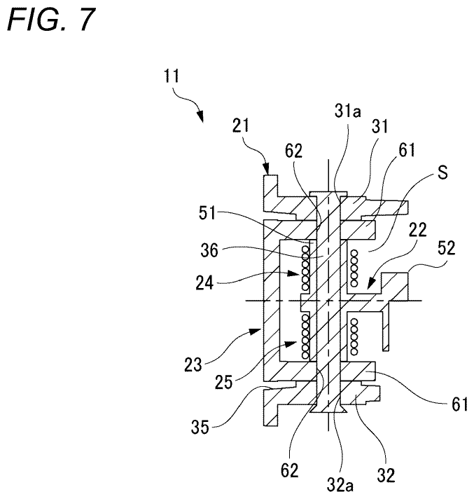

FIG. 2 is a perspective view of the handle device 11 according to the present embodiment. FIG. 3 is an exploded perspective view of the handle device 11 according to the present embodiment. FIG. 4 is a front view of the handle device 11 according to the present embodiment. FIG. 5 is a rear view of the handle device 11 according to the present embodiment. FIG. 6 is a cross-sectional view taken along VI-VI in FIG. 4. FIG. 7 is a cross-sectional view taken along VII-VII in FIG. 4.

As illustrated in FIGS. 2 to 7, the handle device 11 includes a base 21, a lever 22, a handle 23, a first spring 24, and a second spring 25. The first spring 24 and the second spring 25 respectively constitute a first elastic portion and a second elastic portion of the present disclosure.

The base 21 is attached to the door D. The base 21 includes an upper side portion 31 and a lower side portion 32 which are disposed in a vertical arrangement, and side portions 33 and 34 which respectively connect both ends of the upper side portion 31 and the lower side portion 32. As a result, the base 21 is formed in a frame shape having an accommodation space S in which front surface sides form a rectangular opening portion 35.

Fixing holes 31a and 32a are respectively formed in the upper side portion 31 and the lower side portion 32 of the base 21 to be close to the side portion 33. The fixing holes 31a and 32a are formed at positions facing each other, and a rotation shaft 36 is passed through and fixed to the fixing holes 31a and 32a. Further, a rear wall portion 37 extending from the side portion 34 toward the side portion 33 is formed on a rear portion side of the base 21.

Cable attachment portions 41 and 42 are provided at a rear portion of the base 21. These cable attachment portions 41 and 42 are respectively formed in the side portions 33 and 34. An end portion of a covering portion 45 through which the latch-side cable 15 passes is held in the cable attachment portion 41, and an end portion of a covering portion 46 through which the cylinder-side cable 16 passes is held in the cable attachment portion 42.

Further, a pair of fixing pieces 48 each having a hole portion 47 are formed in each of the upper side portion 31 and the lower side portion 32 of the base 21. The base 21 is attached to the inner panel of the door D by screwing screws (not illustrated) inserted into the hole portions 47 of the fixing pieces 48 into screw holes formed in the inner panel of the door D.

The lever 22 is accommodated in the accommodation space S of the base 21. The lever 22 includes a cylindrical portion 51 and a cable holding portion 52. The rotation shaft 36 is inserted through the cylindrical portion 51. As a result, the lever 22 is supported to be rotatable about the rotation shaft 36 extending in a vertical direction in the accommodation space S of the base 21.

The cable holding portion 52 includes a latch cable holding portion 55 and a cylinder cable holding portion 56. An engaging portion 15a provided at an end portion of the latch-side cable 15 is engaged with the latch cable holding portion 55. Further, an engaging portion 16a provided at an end portion of the cylinder-side cable 16 is engaged with the cylinder cable holding portion 56.

The latch cable holding portion 55 includes a hole portion 55a and a slit 55b connected to the hole portion 55a. The end portion of the latch-side cable 15 is connected to the latch cable holding portion 55 by inserting the latch-side cable 15 through the slit 55b and accommodating the engaging portion 15a in the hole portion 55a.

The cylinder cable holding portion 56 includes an elongated hole portion 56a and a slit 56b connected to the elongated hole portion 56a. The end portion of the cylinder-side cable 16 is connected to the cylinder cable holding portion 56 by inserting the cylinder-side cable 16 through the slit 56b and accommodating the engaging portion 16a in the elongated hole portion 56a. The elongated hole portion 56a of the cylinder cable holding portion 56 is formed in an arc shape around the rotation shaft 36. In addition, the engaging portion 16a of the cylinder-side cable 16 accommodated in the elongated hole portion 56a of the cylinder cable holding portion 56 is movable in the elongated hole portion 56a.

The handle 23 is formed in a flat plate shape substantially matching the opening portion 35 of the base 21, and is fitted and assembled into the accommodation space S of the base 21 from the opening portion 35. In the present embodiment, it is assumed that the handle 23 is used as an emergency handle when a unit for electronically controlling the door lock device 12 cannot be used, for example. Therefore, by causing the shape of the handle 23 to substantially match the opening portion 35 of the base 21 and making a gap therebetween as small as possible, the handle 23 is made inconspicuous to improve designability and is made difficult to be operated except in an emergency. The handle 23 includes, at its upper and lower edge portions, support pieces 61 protruding in a direction of assembling to the base 21. An insertion hole 62 is formed in each of the support pieces 61, and the rotation shaft 36 is inserted through the insertion holes 62. As a result, the handle 23 is supported to be rotatable about the rotation shaft 36 extending in the vertical direction. Further, a locking piece 63 protruding in the direction of assembling to the base 21 is formed in one side portion of the handle 23.

The first spring 24 is a torsion spring and includes a pair of arm portions 24a and 24b. Similarly, the second spring 25 is a torsion spring and includes a pair of arm portions 25a and 25b.

An upper portion of the cylindrical portion 51 in the lever 22 is inserted into the first spring 24, and a lower portion of the cylindrical portion 51 in the lever 22 is inserted into the second spring 25. As a result, the first spring 24 and the second spring 25 are attached to the lever 22.

In the first spring 24, the arm portion 24a is locked to the rear wall portion 37 of the base 21, and the arm portion 24b is locked to the cable holding portion 52 of the lever 22. Then, the lever 22 is biased by the first spring 24 in a rotation direction Ra that serves as one direction around the rotation shaft 36 (see FIG. 6).

In the second spring 25, the arm portion 25a is locked to the rear wall portion 37 of the base 21, and the arm portion 25b is locked to the locking piece 63 of the handle 23. Then, the handle 23 is biased by the second spring 25 in the rotation direction Ra that serves as the one direction around the rotation shaft 36 (see FIG. 6).

In the handle 23 biased by the second spring 25 in the rotation direction Ra serving as the one direction, the locking piece 63 at the one side portion abuts against a regulating wall 38 formed in the base 21 (see FIG. 6). As a result, the handle 23 is regulated from rotating in the rotation direction Ra by a biasing force of the second spring 25 in a state in which the opening portion 35 of the accommodation space S of the base 21 is closed. Further, the lever 22 biased by the first spring 24 in the rotation direction Ra serving as the one direction is regulated from rotating in the rotation direction Ra by a biasing force of the first spring 24 because the cable holding portion 52 abuts against the locking piece 63 of the handle 23.

In the handle device 11 having the above structure, the latch-side cable 15 is routed to extend forward in the rotation direction Ra serving as the one direction of the lever 22 (toward the front side of the vehicle), and the cylinder-side cable 16 is routed to extend forward in a rotation direction Rb serving as the other direction (toward the rear side of the vehicle), which is opposite to the rotation direction Ra of one direction of the lever 22 (see FIG. 6).

Next, a case will be described in which the closed state of the door D achieved by the door lock device 12 is released in the door device 14 that includes the handle device 11 having the above structure.

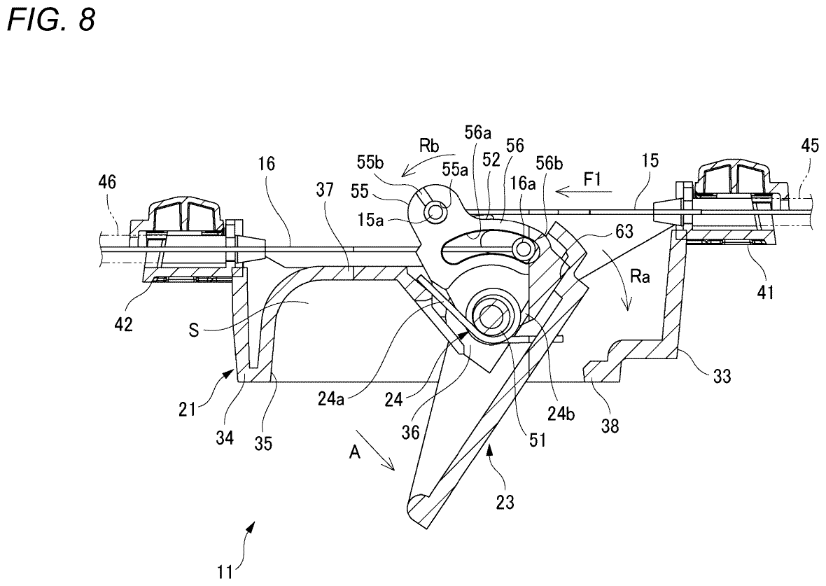

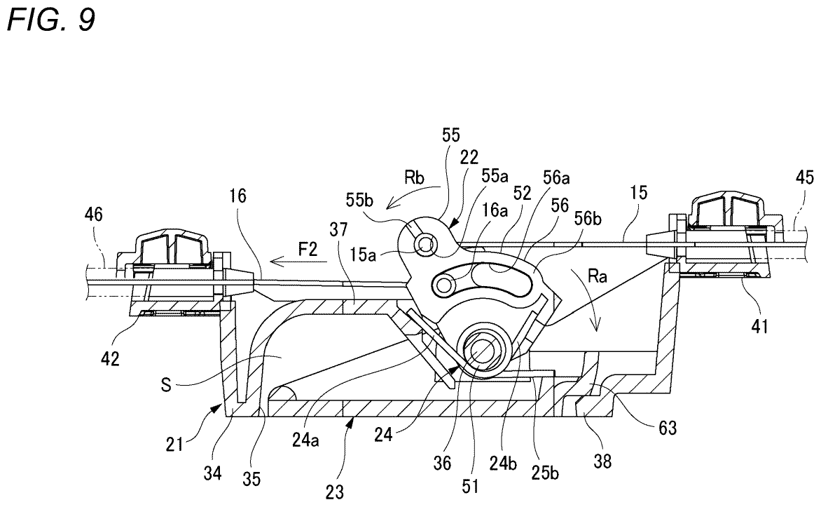

Each of FIG. 8 and FIG. 9 is a view corresponding to the cross-sectional view taken along VI-VI in FIG. 4 for illustrating a movement of the handle device 11.

### (Opening Operation of Handle Device 11)

In order to release the closed state of the door D achieved by the door lock device 12 from the indoor side by using the handle device 11, as illustrated in FIG. 8, the other side portion of the handle 23 in the handle device 11 is gripped, and the handle 23 is pulled forward (in the direction of arrow A in FIG. 8). Then, the handle 23 is rotated in the rotation direction Rb serving as the other direction against the biasing force of the second spring 25. Then, the cable holding portion 52 of the lever 22, which is locked to the locking piece 63 of the handle 23, is pressed by the handle 23, and the lever 22 is rotated in the rotation direction Rb serving as the other direction against the biasing force of the first spring 24. As a result, the latch-side cable 15 connected to the latch cable holding portion 55 of the lever 22 is pulled to generate a pulling force F1, the door lock device 12 is shifted to a unlocked state from a locked state by the pulling force F1, the engagement of the striker with the latch is released in the unlocked state, and then the door D is opened.

Here, when the lever 22 is rotated in the rotation direction Rb serving as the other direction, the engaging portion 16a of the cylinder-side cable 16 moves in the elongated hole portion 56a of the cylinder cable holding portion 56. In other words, since the cylinder cable holding portion 56 does not transmit a rotational force of the lever 22 to the engaging portion 16a of the cylinder-side cable 16, the engaging portion 16a does not move from an initial position. As a result, the occurrence of bending due to the cylinder-side cable 16 being pushed in by the lever 22 rotated together with the handle 23 is limited. Therefore, the cylinder-side cable 16 does not bend and slip out from the slit 56b, and the engaging portion 16a is not disengaged from the cylinder cable holding portion 56.

In the handle device 11, the opening portion 35 of the accommodation space S in the base 21 is closed by the handle 23. Therefore, when the handle 23 is subjected to an opening operation, the one side portion of the handle 23 is pushed in with respect to the rotation shaft 36 biased by the second spring 25. Then, the handle 23 is rotated in the rotation direction Rb serving as the other direction, so that a gap is formed between the other side portion of the handle 23 and the base 21. Therefore, the handle 23 can be rotated by inserting a finger into the gap and pulling the handle 23 forward.

### (Opening Operation of Cylinder Lock 13)

In order to release the closed state of the door D achieved by the door lock device 12 from the outdoor side, the cylinder lock 13 provided on the outdoor side is operated. The cylinder lock 13 is provided integrally with the outside handle or in the vicinity of the outside handle with respect to the door D, and thus, when the cylinder lock 13 is operated, as illustrated in FIG. 9, a pulling force F2 is applied to the cylinder-side cable 16 by the operation force of the cylinder lock 13. Then, by the pulling force F2 applied to the cylinder-side cable 16, the lever 22 is rotated in the rotation direction Rb serving as the other direction against the biasing force of the first spring 24. As a result, the latch-side cable 15 connected to the latch cable holding portion 55 of the lever 22 is pulled, the door lock device 12 is shifted to the unlocked state from the locked state, the engagement of the striker with the latch is released in the unlocked state, and then the door D is opened.

Regarding the operation from the outdoor side, in order to prevent improper unlocking by an operation of another person other than a legitimate owner of the vehicle, an example is described in which the operation is performed by the cylinder lock 13 that is operated by only a key held by the owner, but the present disclosure is not limited thereto. Since it is sufficient to allow only the owner of the vehicle to access an operation portion, for example, the door may be provided with an outdoor-side operation portion such as a handle, a lever, or a link hook for directly pulling a wire, the outdoor-side operation portion may be usually regulated so as not to be directly operated, and the regulation may be released when the owner of the vehicle is authenticated by using the cylinder lock or an NFC authentication device.

At this time, only the lever 22 is rotated, and the handle 23 is not rotated and is maintained in the state of closing the opening portion 35 of the accommodation space S in the base 21. Therefore, the handle 23 of the handle device 11 can be opened along with the opening operation of the cylinder lock 13 without impairing an appearance, and a good appearance can be secured.

The first spring 24 and the second spring 25 may have equal biasing forces, and may have different biasing forces.

Here, in the case of the opening operation of the cylinder lock 13, only the lever 22 is rotated, but in the case of the opening operation of the handle device 11, the handle 23 and the lever 22 are rotated, and thus an operation force larger than that used for the opening operation of the cylinder lock 13 is required. Therefore, by setting the biasing force of the second spring 25 smaller than the biasing force of the first spring 24, the operability during the opening operation of the handle device 11 can be improved.

In addition, in an electronically controlled door device in which the opening operation of the handle device 11 is not performed in a usual state, the opening operation of the handle device 11 is performed in an emergency. Therefore, in this case, in order to prevent the handle device 11, which is not usually used, from being accidentally operated, the biasing force of the second spring 25 that biases the handle 23 may be equal to or larger than the biasing force of the first spring 24.

As described above, according to the door device 14 including the handle device 11 of the present embodiment, the engagement of the door D with the vehicle body achieved by the latch of the door lock device 12 can be released by operating the handle 23 of the handle device 11 or the cylinder lock 13.

As described above, according to the handle device 11 of the present embodiment, the lever 22 connected to the latch of the door lock device 12 via the latch-side cable 15 can be rotated by the operation of the handle 23 or the operation of the cylinder lock 13 connected via the cylinder-side cable 16, and the engagement of the door D with the vehicle body achieved by the latch can be released. That is, a path for a routing member that transmits the operation force of the handle 23 or the operation force of the cylinder lock 13 can be set to one path, and the structure can be simplified. Accordingly, high assemblability can be achieved while reducing cost and weight.

In addition, since the lever 22 and the handle 23 are supported to be rotatable about the same rotation shaft 36 with respect to the base 21 in the structure, the number of parts can be reduced and a reduction in size can be achieved.

Further, in the handle device 11 according to the present embodiment, a cable is used as the routing member for transmitting the operation force. That is, since the cable is drawn around inside the door D according to the structure, restrictions during routing the cable inside the door D can be reduced as compared with a structure using a rod.

The present disclosure is not limited to the above-described embodiment, and modifications, improvements, and the like can be made as appropriate. In addition, materials, shapes, dimensions, numbers, arrangement positions, and the like of the constituent elements in the above-described embodiment are optional and are not limited as long as the present disclosure can be achieved.

According to the embodiment of the present disclosure, a handle device (11) to be provided in a vehicle door (D) and for releasing engagement of a latch provided in a door lock mechanism (12) of the door (D) with a vehicle body, includes:
a base (21) to be attached to the door (D);
a lever (22) supported by the base (21) to be rotatable;
a first biasing portion (first spring 24) configured to bias the lever (22) in a rotation direction (Ra) serving as one direction;
an indoor handle (handle 23) supported by the base (21) to be rotatable about the same rotation shaft (36) as that of the lever (22), and configured to be rotated in a rotation direction (Rb) serving as the other direction to lock the lever (22) and rotate the lever (22) in the rotation direction (Rb) serving as the other direction;
a second biasing portion (second spring 25) configured to bias the indoor handle (handle 23) in the rotation direction (Ra) serving as the one direction;
a latch-side routing member (latch-side cable 15) connected to the lever (22) and extending forward in the rotation direction (Ra) serving as the one direction to connect the latch; and
a cylinder-side routing member (cylinder-side cable 16) connected to the lever (22) and extending forward in the rotation direction (Rb) serving as the other direction to connect to a cylinder lock (13), wherein
the lever (22) includes, at a connection portion with the cylinder-side routing member (cylinder-side cable 16), an elongated hole portion (56a) having an arc shape around the rotation shaft (36), and
a connection end (engaging portion 16a) of the cylinder-side routing member (cylinder-side cable 16) is accommodated and held in the elongated hole portion (56a), and is moved in the elongated hole portion (56a) when the lever (22) is locked to the indoor handle (handle 23) and is rotated.

According to the handle device having this configuration, the lever connected to the latch of the door lock device via the latch-side routing member can be rotated by the operation of the handle or the operation of the cylinder lock connected via the cylinder-side routing member, and the engagement of the door with the vehicle body achieved by the latch can be released. That is, the path for the routing member that transmits the operation force of the handle or the operation force of the cylinder lock can be set to one path, and the structure can be simplified. Accordingly, the high assemblability can be achieved while reducing cost and weight.

In addition, since the lever and the handle are supported to be rotatable about the same rotation shaft with respect to the base in the structure, the number of parts can be reduced and the reduction in size can be achieved.

The latch-side routing member (latch-side cable 15) and the cylinder-side routing member (cylinder-side cable 16) may be cables.

According to the handle device having this configuration, a cable is used as the routing member that transmits the operation force. That is, since the cable is drawn around inside the door according to the structure, the restrictions during routing the cable inside the door can be reduced as compared with the structure using a rod.

A door device includes: an above-described handle device (11),
a cylinder lock (13) to which the cylinder-side routing member (cylinder-side cable 16) is connected, and
a door lock device (12) to which the latch-side routing member (latch-side cable 15) is connected.

According to the door device having this configuration, the engagement of the door with the vehicle body achieved by the latch of the door lock device can be released by operating the handle of the handle device or the cylinder lock.

Although various embodiments have been described above, it is needless to say that the present invention is not limited to such embodiments. It is apparent to those skilled in the art that various variations or modifications can be conceived within the scope described in the claims, and it is understood that the variations or modifications naturally fall within the technical scope of the present invention. Further, the constituent elements described in the above embodiment may be freely combined without departing from the spirit of the invention.

What is claimed is:

1. A handle device to be provided in a vehicle door and for releasing engagement of a latch provided in a door lock mechanism of the door with a vehicle body, comprising:
a base to be attached to the door;
a lever supported by the base to be rotatable;
a first biasing portion configured to bias the lever in a rotation direction serving as one direction;
an indoor handle supported by the base to be rotatable about the same rotation shaft as that of the lever, and configured to be rotated in a rotation direction serving as the other direction to lock the lever and rotate the lever in the rotation direction serving as the other direction;
a second biasing portion configured to bias the indoor handle in the rotation direction serving as the one direction;
a latch-side routing member connected to the lever and extending forward in the rotation direction serving as the one direction to connect the latch; and
a cylinder-side routing member connected to the lever and extending forward in the rotation direction serving as the other direction to connect to a cylinder lock, wherein
the lever includes, at a connection portion with the cylinder-side routing member, an elongated hole portion having an arc shape around the rotation shaft, and
a connection end of the cylinder-side routing member is accommodated and held in the elongated hole portion, and is moved in the elongated hole portion when the lever is locked to the indoor handle and is rotated.

2. The handle device according to claim 1, wherein
the latch-side routing member and the cylinder-side routing member are cables.

3. A door device comprising:
a handle device according to claim 1;
a cylinder lock to which the cylinder-side routing member is connected; and
a door lock device to which the latch-side routing member is connected.

4. A door device comprising:
a handle device according to claim 2;
a cylinder lock to which the cylinder-side routing member is connected; and
a door lock device to which the latch-side routing member is connected.
